(19) United States
(12) Patent Application Publication
(10) Pub. No.: US 2006/0013574 A1
(43) Pub. Date: Jan. 19, 2006

(54) Electrical heater, heating heat exchanger and vehicle air conditioner

(75) Inventors: Hitoshi Ito, Toyohashi-city (JP); Eiichi Torigoe, Anjo-city (JP); Mitsugu Nakamura, Anjo-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/230,264

(22) Filed: Sep. 19, 2005

Related U.S. Application Data
(62) Division of application No. 10/863,801, filed on Jun. 8, 2004.

(30) Foreign Application Priority Data
Jun. 10, 2003 (JP) 2003-165110

(51) Int. Cl. F24H 1/10; H05B 3/78

(52) U.S. Cl. 392/485

(57) ABSTRACT

An electrical heater includes plural heating body plates arranged in parallel with each other to define an air passage between adjacent two thereof, a positive electrode member joined to one end side of each heating body plate, and a negative electrode member joined to the other end side of each heating body plate. In the electrical heater, the heating body plates are arranged to directly heat air passing through the air passage when electrical power is supplied to the heating body plates through the electrode members. Accordingly, the electrical heater can effectively heat air with a simple structure.

### CROSS-REFERENCE TO RELATED APPLICATIONS

This application is a divisional of U.S. patent application Ser. No. 10/863,801 filed on Jun. 8, 2004. This application claims the benefit of JP 2003-165110, filed Jun. 10, 2003. The disclosure of the above application is incorporated herein by reference.

### FIELD OF THE INVENTION

The present invention relates to an electrical heater, a heating heat exchanger including a heater core integrated with the electrical heater, and an air conditioner for a vehicle using the electrical heater or the heating heat exchanger.

### BACKGROUND OF THE INVENTION

Various kinds of electrical heaters having an electric heating body for generating heat by flowing an electric current through this electric heating body are conventionally proposed (e.g., JP-B2-3274234). In this prior art, a PTC heating body manufactured by ceramic and suddenly increased in an electric resistance value at a predetermined temperature is used as the electric heating body, and the heating temperature can be self-controlled to the predetermined temperature.

Because the PTC heating body is manufactured by ceramic, the freedom degree of the selection of a molding shape is low. Therefore, a fin member for improving a heat radiating property must be set separately from the PTC heating body heater. In the above prior art, a gate fin is combined with the PTC heating body heater through a metallic plate, and heat exchange of the PTC heating body and air is performed through this gate fin.

The generation heat of the PTC heating body is thermally conducted to the corrugate fin through the metallic plate and is radiated from the corrugated fin to air. Accordingly, for example, even when the heat is generated in the PTC heating body itself at 160° C., the temperature is reduced until about 110° C. in the corrugated fin by the existence of the above heat transmission path. As this result, fin efficiency is reduced and heat radiating performance becomes worse.

Further, a mechanism for pressing and closely attaching the PTC heating body, the metallic plate and the corrugated fin by an elastic member such as a spring, etc. is set to preferably improve the thermal conduction from the PTC heating body to the corrugated fin. Therefore, the structure of this heater becomes complicated.

### SUMMARY OF THE INVENTION

In view of the above-described problems, it is an object of the present invention to provide an electrical heater which effectively improves heat radiating performance while having a simple structure.

According to an aspect of the present invention, an electrical heater includes a plurality of heating body plates arranged in parallel with each other to define an air passage through which air flows between adjacent two thereof, a positive electrode member joined to one end side of each heating body plate, and a negative electrode member joined to the other end side of each heating body plate. In the electrical heater, the heating body plates are arranged to directly heat air passing through the air passage when electrical power is supplied to the heating body plates through the electrode members. In the present invention, because the heating body plates directly define the air passage through which air flows to directly heat air flowing through the air passage, heat radiating performance of the electrical heater can be improved while the electrical heater has a simple structure. Each of the heating body plates can be formed to have a flat shape or a wave shape. When the heating body plates are arranged in such a manner that the wave shape is bent in a direction perpendicular to an air flow direction in the air passage, heat transmitting performance of air can be effectively improved in the electrical heater. Alternatively, each of the heating body plates has protrusion portions protruding from at least one of face and back surfaces of each heating body plate to the air passage.

For example, the positive electrode member is arranged at one end side of each heating body plate in the air flow direction, and the negative electrode member is arranged at the other end side of each heating body plate in the air flow direction. Further, each of the heating body plates can be molded by using an electrically conductive resin in which an electrically conductive filler is mixed to have an electrical conductivity. Generally, the electrically conductive resin has a positive resistance temperature characteristic in which an electrical resistance increases at a predetermined temperature or more. In addition, each of the heating body plates is molded integrally with the positive electrode member and the negative electrode member.

According to another aspect of the present invention, an electrical heater includes a single heating body plate bent in a spiral shape by interposing an air gap portion at a predetermined interval so as to define air passages by using the air gap portion, a positive electrode member joined to one end side of the heating body plate, and a negative electrode member joined to the other end side of the heating body plate. In addition, the heating body plate is disposed to directly heat air passing through the air passages when electrical power is supplied to the heating body plate through the electrode members. In this case, the structure of the electrical heater can be made simple while the radiating performance of the electrical heater can be improved. Even in this case, the positive electrode member can be arranged at one end side of the heating body plate in an air flow direction of the air passages, and the negative electrode member can be arranged at the other end side of the heating body plate in the air flow direction. In this case, the resistance value of the heating body plate can be set at a suitable value without relating to the length of the spiral shape in the spiral direction. Even in this case, the heating body plate can be molded integrally with the positive electrode member and the negative electrode member.

According to a further another aspect of the present invention, an electrical heater includes a block-shaped heating body having a plurality of ventilation hole through which air flows, a positive electrode member joined to one end side of the block-shaped heating body, and a negative electrode member joined to the other end side of the block-shaped heating body. In the electrical heater, the heating body is disposed to directly heat air passing through the ventilation holes when electrical power is supplied to the heating body through the electrode members. Even in this case, the electrical heater can effectively heat air.

For example, the heating body is molded to have a rectangular parallelepiped shape by using an electrically conductive resin in which an electrically conductive filler is mixed to have an electrical conductivity, the positive electrode member is arranged at one of two opposite surfaces of the heating body parallel to an air flow direction of the ventilation holes, and the negative electrode member is arranged at the other one of the two opposite surfaces of the heating body.

The electrical heater can be suitably used for a vehicle air conditioner having a heater core which heats air to be blown into a vehicle passenger compartment by using hot water as a heating source. In this case, the electrical heater is disposed at a downstream air side of the heater core to heat air after passing through the heater core.

According to a further another aspect of the present invention, a heating heat exchanger includes a plurality of heat transfer plates arranged in parallel with each other at a predetermined interval to define an air passage through which air flows between adjacent two thereof, a plurality of heating body plates each of which is integrated with a corresponding one of the heat transfer plates. Each of the heat transfer plates has a plurality of fluid passages through which a fluid flows to heat air passing through the air passage, and the heating body plates generate heat when electrical power is supplied thereto. In the heating heat exchanger, the heat transfer plates and the heating body plates are arranged to heat air passing through the air passages by using the hot water and the generated heat as heating sources. Accordingly even when the temperature of the fluid is low, air passing through the heating heat exchanger can be effectively heated by the electrical heater.

For example, the heating body plates are made of an electrically conductive resin in which an electrically conductive filler is mixed to have an electrical conductivity, and each of heating body plates is molded integrally with the corresponding one of the heat transfer plates. In this case, the heating heat exchanger can be readily formed. The heating heat exchanger can be suitably used for a vehicle air conditioner, for example.

### BRIEF DESCRIPTION OF THE DRAWINGS

Other objects, features and advantages of the present invention will become more apparent from the following detailed description made with reference to the accompanying drawings, in which:

FIG. 1 is a schematic diagram showing an interior air conditioning unit portion of an air conditioner for a vehicle according to embodiments of the present invention;

FIG. 2 is a perspective view showing an electrical heater according to a first embodiment of the present invention;

FIG. 3 is a disassembled perspective view showing an electrical heater according to a second embodiment of the present invention;

FIG. 4A is a schematic perspective view showing an example of an electrical heater according to a third embodiment of the present invention, and FIG. 4B is a schematic side view showing another example of the electrical heater according the third embodiment;

FIGS. 5A to 5E are cross-sectional views showing shape examples of a heating body plate of an electrical heater according to a fourth embodiment of the present invention;

FIG. 6A is a perspective view showing the electrical heater according to the fourth embodiment, and FIG. 6B is a cross-sectional view in the section VIB in FIG. 6A;

FIG. 7A is a front view showing an electrical heater according to a fifth embodiment of the present invention, and FIG. 7B is a cross-sectional view showing a heating body plate of the electrical heater according to the fifth embodiment;

FIG. 8 is a front view showing an electrical heater according to a sixth embodiment of the present invention;

FIG. 9 is a perspective view showing an electrical heater according to a seventh embodiment of the present invention;

FIG. 10 is a front view showing an electrical heater according to an eighth embodiment of the present invention;

FIG. 11 is a perspective view showing an electrical heater according to a ninth embodiment of the present invention;

FIG. 12 is a cross-sectional view showing an electrical heater according to a tenth embodiment of the present invention; and

FIG. 13 is a cross-sectional view showing a main part of an integrated structure of a hot-water type heating heat exchanger and an electrical heater, according to an eleventh embodiment of the present invention.

### DETAILED DESCRIPTION OF THE PREFERRED EMBODIMENTS

In the following embodiments, the present invention is typically used for an air conditioner for a vehicle.

### First Embodiment

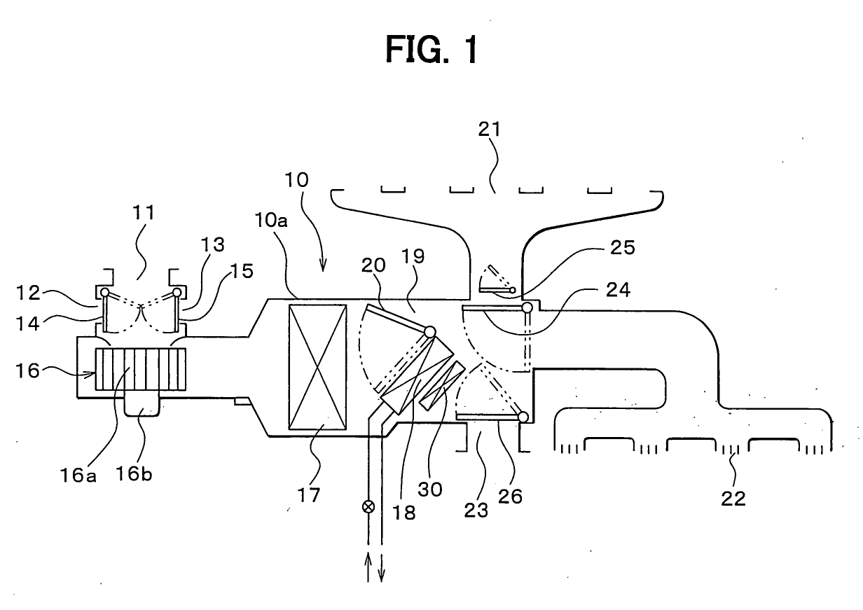

The first embodiment of the present invention will be now described with reference to FIGS. 1 and 2. An air conditioner for a vehicle using an electrical heater of the first embodiment will first be described. FIG. 1 shows the schematic structure of an interior air conditioning unit portion 10 of the air conditioner for a vehicle. This interior air conditioning unit portion 10 is normally mounted to the inside of an unillustrated vehicle dashboard (instrument board) located in the forefront portion of a vehicle passenger compartment. An outside air introducing inlet 11, inside air introducing inlets 12, 13, and inside and outside air switching doors 14, 15 for opening and closing these introducing inlets 11, 12, 13 are arranged in the most upstream portion of an air flow of this interior air conditioning unit portion 10.

Outside air (i.e., air outside the vehicle passenger compartment) or inside air (i.e., air inside the vehicle passenger compartment) introduced from the introducing inlets 11, 12, 13 is blown toward the vehicle passenger compartment through an air passage of an air conditioning case 10a of the interior air conditioning unit portion 10 by a blower 16. In the blower 16, a centrifugal type blowing fan 16a is operated by a motor 16b.

A cooling heat exchanger 17 (i.e., heat exchanger for cooling) is arranged on a downstream side of the blower 16 within the air conditioning case 10a. This cooling heat exchanger 17 is constructed with an evaporator of a well-known refrigerating cycle. A heating heat exchanger 18 (i.e., heat exchanger for heating) is arranged on a downstream side of the cooling heat exchanger 17.

This heating heat exchanger 18 is a heat exchanger of a hot water type (heater core) for heating the air after passing through the cooling heat exchanger 17 by using hot water (engine cooling water) from an unillustrated vehicle engine as a heat source. Further, an electrical heater 30 for immediately heating the vehicle passenger compartment is arranged in a part just after the air of the heating heat exchanger 18 is blown out. Therefore, air after passing through the heating heat exchanger 18 is heated by the electrical heater 30.

A cool air passage 19 is formed on one side of the heating heat exchanger 18 within the air conditioning case 10a. In the cool air passage 19, the air (cool air) after passing through the cooling heat exchanger 17 flows while bypassing the heating heat exchanger 18. An air mix door 20 constructed with a rotatable plate door is arranged between the cooling heat exchanger 17 and the heating heat exchanger 18. This air mix door 20 adjusts the temperature of the blowing-out air to the vehicle passenger compartment by adjusting a flow ratio of warm air passing through the heating heat exchanger 18 and cool air passing through the cool air passage 19.

The conditioned air adjusted in temperature by the air mix door 20 is blown out into the vehicle passenger compartment from one or plural ports of a defroster blowing-out port 21, a face blowing-out port 22 and a foot blowing-out port 23. Here, the defroster blowing-out port 21 blows out the conditioned air toward a front window glass (front windshield) of the vehicle. The face blowing-out port 22 blows out the conditioned air toward the upper half body of a passenger in the vehicle passenger compartment. The foot blowing-out port 23 blows out the conditioned air toward the foot side of the passenger in the vehicle passenger compartment. These blowing-out ports 21, 22, 23 are selectively opened and closed by blowing-out mode doors 24 to 26 constructed with rotatable plate doors.

FIG. 2 is a perspective view showing the electrical heater 30 in the first embodiment. In the electrical heater 30, the plural heating body plates 31 (heat-generating plates) are spaced at a predetermined interval and are laminated and arranged in parallel with each other.

In this heating body plate 31, an electrically conductive resin material is used as its material in this example. The heating body plate 31 is molded by this electrically conductive resin material in the shape of an elongated rectangular thin plate. The electrically conductive resin material is a material having the electrically conductive property and is formed by mixing an electrically conductive filler of a fine granular shape of a metal, carbon, a semiconductor, etc. into a resin material. By this electrically conductive resin material, a predetermined required electric resistance value required as the electrical heater 30 can be set.

For example, the heating body plate 31 has about 0.3 mm in thickness, and the mutual interval between the adjacent heating body plates 31 is set to about 2 mm. An air passage 32 for passing the air “a” is formed between the heating body plates 31 adjacent to each other at this interval.

Electrode members 33, 34 are arranged in both end portions of the heating body plate 31 in its longitudinal direction (vertical direction in FIG. 2). The heating body plate 31 and the electrode members 33, 34 are integrally joined to each other. Each of these electrode members 33, 34 is a member of a plate shape molded by an electrically conductive body of copper, etc. More specifically, each of the electrode members 33, 34 is molded in a rectangular plate shape covering the entire end portion of a laminating arrangement structure body of the plural heating body plates 31, and are integrally joined to the end portions of all the heating body plates 31. For example, a joining material such as silver paste excellent in the electrically conductive property is used as a joining means. The electrode members 33, 34 and the end portions of the heating body plates 31 are integrally joined to each other through this joining material.

The laminating arrangement structure of the plural heating body plates 31 can be mechanically integrally held by the electrode members 33, 34, and both the end portions of the plural heating body plates 31 in their longitudinal direction are respectively electrically connected to the electrode members 33, 34. In the two electrode members 33, 34, a positive electrode terminal portion 36 is connected to the positive electrode member 33 on the upper side through a lead wire 35. Further, a negative electrode terminal portion 38 is connected to the negative electrode member 34 on the lower side through a lead wire 37. An output portion of a control device 39 (ECU) is connected to this positive electrode terminal portion 36, and the turning-on and turning-off operations of an electric current conducted to the plural heating body plates 31 are automatically controlled by the output of the control device 39.

In a heating operation of the vehicle passenger compartment in winter, the water temperature of the vehicle engine is reduced to a very low temperature similar to the outside air temperature just after the vehicle engine is started. Therefore, the heating heat exchanger 18 cannot heat air to be blown into the vehicle passenger compartment by using the hot water of the vehicle engine as a heat source. Accordingly, when only the heating heat exchanger 18 of a hot water type is used in the air conditioning unit portion 10, the heating operation for heating the vehicle passenger compartment cannot be performed just after the vehicle engine is started. Therefore, the comfortable property in the vehicle passenger compartment is greatly damaged.

In this embodiment, a low temperature of the hot water (engine cooling water) in the heating operation in winter is determined by the control device 39 and the electric current conducting circuit between the positive electrode terminal portion 36 of the electrical heater 30 and an unillustrated vehicle mounting battery is automatically set to the ON state and the electric current is conducted to the heating body plate 31. The control device 39 automatically supplies the electric current to the heating body plate 31 when it is determined that the water temperature from the engine detected by an unillustrated water temperature sensor is a predetermined temperature or less and it is an environmental condition where the heating operation of the vehicle passenger compartment is required. For example, when the temperature of the vehicle passenger compartment is lower than a predetermined temperature, or when the temperature of outside air outside the vehicle passenger compartment is lower than a predetermined temperature, it is determined that the heating operation for heating the passenger compartment is required.

Since the heating body plate 31 generates heat by supplying the electric current to the heating body plate 31, the blowing air can be directly heated by the heating body plate 31. Even when the water from the vehicle engine is low, the interior of the vehicle passenger compartment can be also effectively immediately heated by blowing-out this heated air (warm air) of the electrical heater 30 into the vehicle passenger compartment from the foot blowing-out port 23, etc.

The blower 16 is operated when the electric current is supplied to the motor 16b by an output signal of the control device 39 at a time where electrical current is supplied to the heating body plate 31. In this case, the blowing air of the blower 16 passes through the cooling heat exchanger 17 and the heating heat exchanger 18, and then passes through many air passages 32 between the heating body plates 31 of the electrical heater 30.

Because the surface of each heating body plate 31 directly faces the air flow of the air passage 32 to directly contact the air, the generation heat of each heating body plate 31 can be directly transmitted to the air passing through the air passage 32. Because a member itself corresponding to the fin located in the air flow becomes the heat generating body (heating body plate 3), no problem of a reduction in fin efficiency is caused. Further, because the generation heat of each heating body plate 31 can be almost given to the air flow, the heat radiating performance of the electrical heater 30 can be improved. Accordingly, electric power consumption of the electrical heater 30 can be effectively reduced while heating performance of the electrical heater can be improved.

Further, because each heating body plate 31 generates heat on its entire surface, the air flowing through the air passage 32 can be uniformly heated without irregularities, and the temperature distribution of the blowing-out air can be uniformed.

Each air passage 32 is constructed with the distance between the adjacent heating body plates 31, and the surface of each heating body plate 31 is constructed so as to directly face the air flow. Accordingly, a body separated from the heating body plate, such as a metallic plate, a fin, a spring mechanism for pressing is not required. Therefore, the structure of the electrical heater 30 can be simplified.

The electrically conductive resin material of the heating body plate 31 in this embodiment can have PTC heating body characteristics by a material composition including no Pb, and it is also advantageous in view of environmental protection.

A material obtained by mixing carbon particles as an electrically conductive filler into a crystalline polymer can be used as an example of the electrically conductive resin material having the PTC heating body characteristics. In this electrically conductive resin material, the PTC heating body characteristics appear by the following principle. That is, when the temperature of the electrically conductive resin material (heating body plate 31) rises and approaches a crystal melting point of the crystalline polymer, the coefficient of thermal expansion of the crystalline polymer is increased. Therefore, the distances between carbon particles in the electrically conductive resin material are increased and the electric resistance value is suddenly increased (the appearance of the PTC heating body characteristics). Accordingly, the temperature of the heating body plate 31 can be self-controlled to the temperature near the crystal melting point of the crystalline polymer by suddenly reducing the electric current flowing through the heating body plate 31 at the temperature near the crystal melting point of the crystalline polymer.

### Second Embodiment

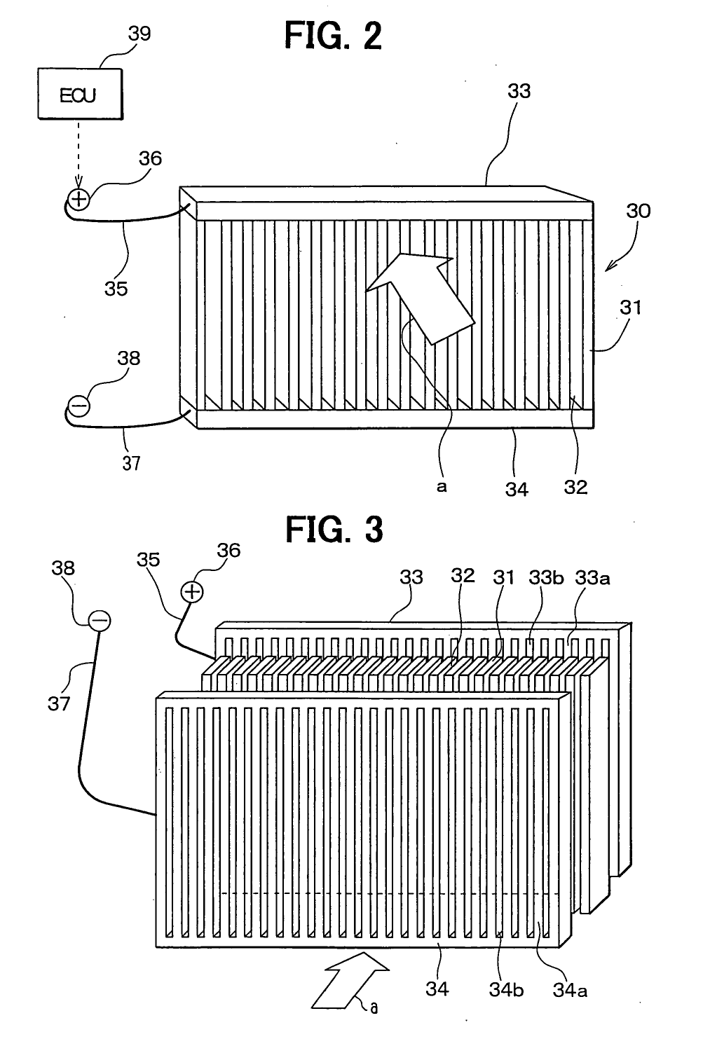

The second embodiment of the present invention will be now described with reference to FIG. 3.

In the above-described first embodiment, the electrode members 33, 34 are arranged in both the end portions of each of the plural heating body plates 31 in their longitudinal direction (vertical direction of FIG. 1). That is, the electrode members 33, 34 extend at both the end portions of each heating body plate 31 to be parallel to the air flow direction “a”. However, in the second embodiment, as shown in FIG. 3, electrode members 33, 34 are arranged in two end portions of each heating body plate 31 in a short side direction (lateral direction). That is, the electrode members 33, 34 are arranged at the upstream and downstream end portions of the heating body plates 31 in the air flow direction “a”.

Therefore, in the second embodiment, joining portions 33a, 34a of a short strip shape bonded to the upstream and downstream end portions of the respective heating body plates 31, and air gap portions 33b, 34b of a slit shape communicated with the air passages 32 between the adjacent heating body plates 31 are formed in the electrode members 33, 34. Accordingly, air passes through the slit-shaped air gap portions 33b, 34b of the electrode members 33, 34 and the air passages 32 between the adjacent heating body plates 31 as shown by the arrow “a”. In the second embodiment, the other parts are similar to those of the above-described first embodiment.

### Third Embodiment

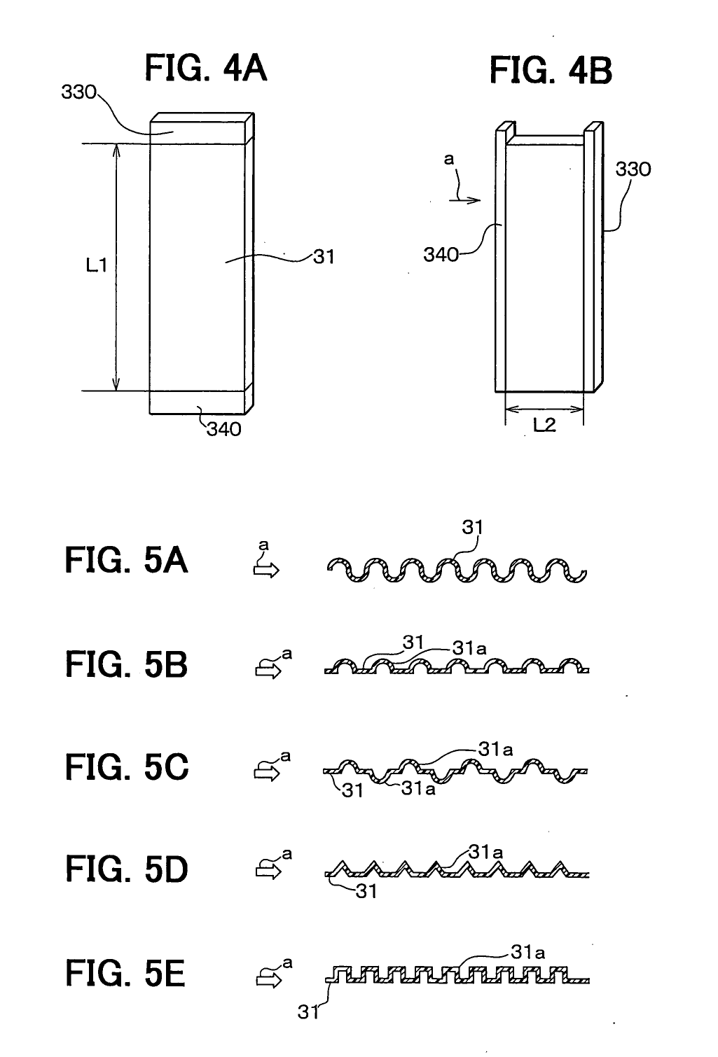

The third embodiment of the present invention will be now described with reference to FIGS. 4A and 4B.

In the above-described first and second embodiments, the heating body plate 31 and the electrode members 33, 34 are respectively molded in advance as separate bodies, and the end portions of the plural heating body plates 31 arranged in parallel with each other are integrally joined to the electrode members 33, 34 of the plate shape. However, in the third embodiment, as shown in FIGS. 4A and 4B, auxiliary electrode members 330, 340 constructed with electrically conductive bodies of copper, etc. are integrally molded in the end portions of the respective heating body plates 31.

Specifically, in FIG. 4A, the auxiliary electrode members 330, 340 constructed with the electrically conductive bodies of copper, etc. are integrally molded with both the end portions of the respective heating body plates 31 in their longitudinal direction (vertical direction of FIG. 1). Further, in FIG. 4B, the auxiliary electrode members 330, 340 constructed with the electrically conductive bodies of copper, etc. are integrally molded with both the end portions of the respective heating body plates 31 in their short side direction, i.e., in both the upstream and downstream end portions in the air flow direction “a”.

When each heating body plate 31 is injection-molded, the auxiliary electrode members 330, 340 can be integrally molded in each heating body plate 31 by an insertion molding method.

In the example of FIG. 4A, the plate-shaped electrode members 33, 34 shown in FIG. 2 are further integrally joined to the auxiliary electrode members 330, 340 of each heating body plate 31. Further, in the example of FIG. 4B, the plate-shaped electrode members 33, 34 shown in FIG. 3 are further integrally joined to the auxiliary electrode members 330, 340 of each heating body plate 31.

In accordance with the third embodiment, when the heating body plate 31 is molded by a resin material, the heating body plate 31 and the auxiliary electrode members 330, 340 can be directly electrically joined to each other by integral molding, and the contact resistance between the heating body plate 31 and the auxiliary electrode members 330, 340 can be reduced. Therefore, a suitable resistance value can be set as the entire electrical heater even when the resistance value proper to the electrically conductive resin constituting the heating body plate 31 is large.

Both the auxiliary electrode members 330, 340 and the electrode members 33, 34 are constructed with electrically conductive bodies of copper, etc., and the electrically conductive bodies contact with each other and are joined to each other. Accordingly, the contact resistance of this electrode joining portion can be greatly reduced.

Further, in the example of FIG. 4B, an inter-electrode distance L2 between the electrode members 330, 340 can be set to be sufficiently smaller than an inter-electrode distance L1 between the electrode members 330, 340 in the example of FIG. 4A. Thus, the resistance value of the entire electrical heater can be set to a suitable resistance value even when the resistance value of the electrically conductive resin constituting the heating body plate 31 is large.

In FIGS. 4A and 4B, the examples in which the auxiliary electrode members 330, 340 are integrally molded to each heating body plate 31, has been described. However, the electrode members 33, 34 of the plate shape shown in FIG. 2 can be integrally molded with both the end portions of the plural heating body plates 31 in their longitudinal direction, instead of the corresponding auxiliary electrode members 330, 340 every each heating body plate 31. Further, the electrode members 33, 34 of the plate shape shown in FIG. 3 can be integrally molded in both the end portions of the heating body plates 31 in their short side direction (both the upstream and downstream end portions in the air flow direction “a”).

### Fourth Embodiment

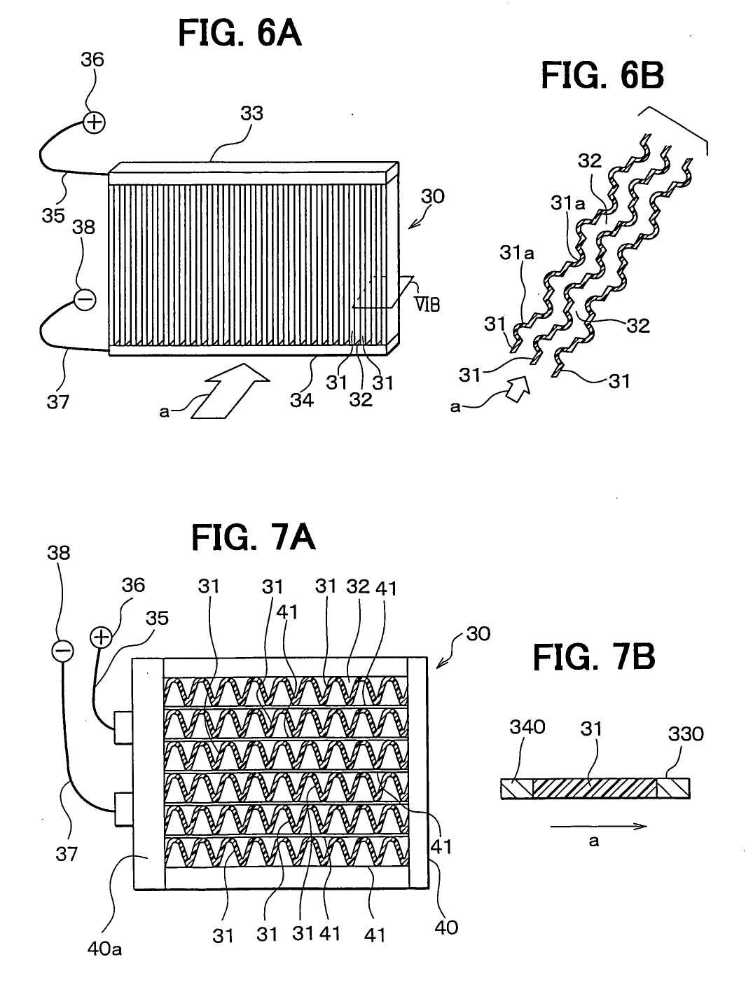

The fourth embodiment of the present invention will be now described with reference to FIGS. 5A-5E and FIG. 6A-6B.

In each of the first to third embodiments, the heating body plate 31 is formed in the shape of a simple flat plate. However, in the fourth embodiment, the heat radiating performance of the heating body plate 31 is improved by changing the shape of the heating body plate 31.

FIG. 5A shows a first example of the fourth embodiment. In this first example of the fourth embodiment, the heating body plate 31 is bent and molded in a wavy shape along the air flow direction “a”. In accordance with this heating body plate 31, the air flow is effectively disturbed by the wavy shape so that the heat transfer rate can be improved and the heat transfer area can be effectively increased.

FIG. 5B shows a second example of the fourth embodiment. In this second example of the present invention, plural hemispherical projections 31a are projected and formed along the air flow direction “a” from one side of a flat plate reference face of the heating body plate 31. In accordance with such a structure, the air flow is disturbed by the hemispherical projection 31a, and the heat transfer rate can be improved and the heat transfer area can be increased.

FIG. 5C shows a third example of the fourth embodiment. In the third example of the fourth embodiment, the hemispherical projections 31a of the above second example are alternately projected and formed on both the front and rear sides from the flat plate reference face of the heating body plate 31 along the air flow direction “a”.

FIG. 5D shows a fourth example of the fourth embodiment. In the fourth example of the fourth embodiment, a triangular projection 31a is projected and formed instead of the hemispherical projection 31a of the above second example. Further, FIG. 5E shows a fifth example of the fourth embodiment. In the fifth example of the fourth embodiment, a rectangular projection 31a is projected and is formed instead of the hemispherical projection 31a of the above second example.

FIG. 6A shows an electrical heater 30 in which heating body plates 31 having the hemispherical projections 31a of FIG. 5C are laminated and arranged in parallel with each other as shown in FIG. 6B. Each of FIGS. 5B to 5E illustrates a sectional shape in which a concave portion is formed inside the projection 31a, but a solid projecting shape having no concave portion inside the projection 31a can be also formed.

In the above-described fourth embodiment of the present invention, the heating body plates 31 can be arranged in such a manner that the wave shape is bent in a direction perpendicular to the air flow direction in the air passages 32. Further, the positive electrode member 33 (330) can be arranged at one end side of the heating body plates 31, and the negative electrode member 34 (340) can be arranged at the other end side of each heating body plate in the air flow direction.

### Fifth Embodiment

The fifth embodiment of the present invention will be now described with reference to FIGS. 7A and 7B.

As shown in FIG. 7A, within a rectangular frame body 40, heating body plates 31 molded to be bent in a wavy shape as shown in FIG. 5A are laminated and arranged by many stages (six stages in the illustrated example) through a support plate 41 between the adjacent heating body plates 31. Each of the support plates 41 is manufactured from resin. An air passage 32 is formed by an air gap portion (clearance) formed by the wavy shape of the heating body plate 31.

Accordingly, air passes through a rectangular opening portion of the frame body 40 and the air gap portion (air passage 32) formed by the wavy shape of the heating body plate 31, and flows in the direction perpendicular to the paper sheet face of FIG. 7A. In this example, as shown in FIG. 7B, auxiliary electrode members 330, 340 are integrally molded with both the end portions of each heating body plate 31 in the air flow direction “a” (the direction perpendicular to the paper sheet face of FIG. 7A). Accordingly, the electrode arranging structure in the fifth embodiment has the same relation as FIG. 4B with respect to the air flow direction “a”. Here, the auxiliary electrode member 330 as one of both the auxiliary electrode members 330, 340 is set as a positive electrode and the other auxiliary electrode member 340 is set as a negative electrode.

A positive electrode member 33 is electrically joined to the positive auxiliary electrode member 330 of each heating body plate 31 and a negative electrode member 34 is electrically joined to the negative auxiliary electrode member 340 of each heating body plate 31. The positive electrode member 33 and the negative electrode member 34 are arranged in a frame portion 40a located on the left-hand side of FIG. 7A within the frame body 40, i.e., within the frame portion 40a located on one end side of the wavy shape of the heating body plate 31. In FIG. 7A, both these electrode members 33, 34 are not illustrated. However, similar to the electrode members in FIG. 2, both these electrode members 33, 34 are connected to terminal portions 36, 38 through lead wires 35, 37. Accordingly, both the electrode members 33, 34 provided within the frame portion 40a have functions in an electrical circuit, similarly to that in FIG. 2.

### Sixth Embodiment

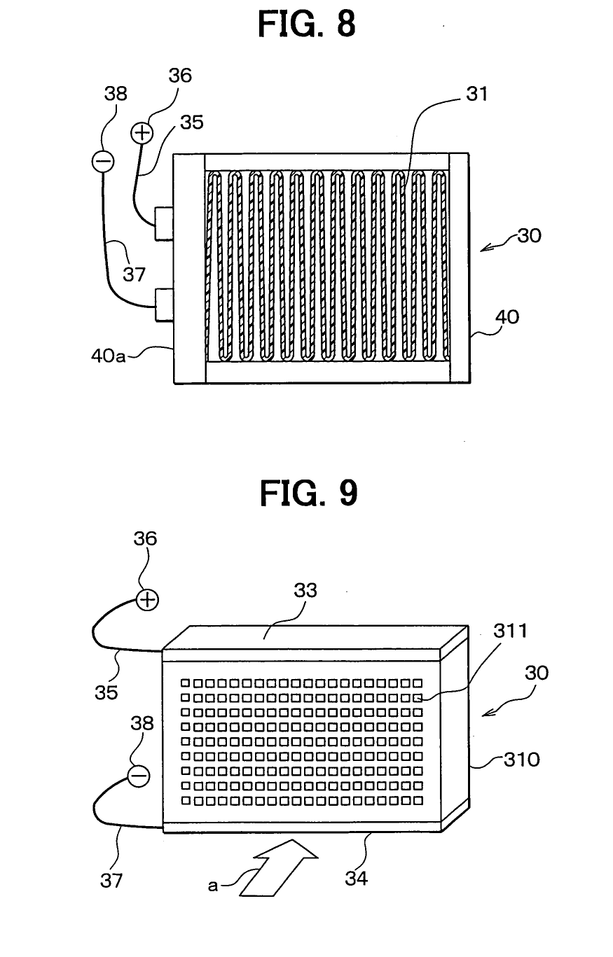

The sixth embodiment of the present invention will be now described with reference to FIG. 8. In the sixth embodiment, only a single heating body plate 31 bent and molded in a wavy shape is arranged within the rectangular frame body 40 manufactured by resin. All the other points are the same as the fifth embodiment.

In accordance with the fifth and sixth embodiments, at least the heating body plates 31, the auxiliary electrode members 330, 340 and the unillustrated electrode members 33, 34 are arranged within the rectangular frame body 40 manufactured by resin. Accordingly, the heating body plate 31 and the electrode members 33, 34, 330, 340 can be protected by the frame body 40. Further, since the heating body plate 31 is bent and molded in the wavy shape, the heat transfer area of the heating body plate 31 can be effectively increased.

### Seventh Embodiment

The seventh embodiment of the present invention will be now described with reference to FIG. 9.

In each of the above embodiments, the electrical heater 30 is constructed by using the heating body plate 31 having the plate shape. However, in the seventh embodiment, as shown in FIG. 9, a heating body 310 (heat-generating member) of a block shape having many ventilation holes 311 for forming air passages is molded by using electrically conductive resin so as to form the electrical heater 30.

More specifically, the heating body 310 is molded in a rectangular parallelepiped shape, and many ventilation holes 311 penetrating through this rectangular parallelepiped body in the air flow direction “a” are bored in parallel with each other. A positive electrode member 33 is arranged in an upper face portion of the heating body 310 and is electrically joined to this upper face portion of the heating body 310. Further, a negative electrode member 34 is arranged in a lower face portion of the heating body 310 and is electrically joined to this lower face portion of the heating body 310. Similar to the electrode members in FIG. 2, both these electrode members 33, 34 are connected to terminal portions 36, 38 through lead wires 35, 37.

In accordance with the seventh embodiment, because air passes through the ventilation holes 311 of the heating body 310, the inner wall face of the heating body 310, defining many ventilation holes 311, becomes a heating portion (a heat radiating portion to the air). Therefore, air passing through the ventilation holes 311 can be efficiently heated.

Further, the structure of the electrical heater 30 can be simplified because the heating body 310 of the electrical heater 30 can be constructed with the single rectangular parallelepiped block that is integrally molded.

Each of FIGS. 2, 3, 6 and 9 shows only the arrangement structure of the heating body plate 31 or the block-shaped heating body 310 and both the electrode members 33, 34. However, in the embodiment of each of these figures, the heating body plate 31 or the block-shaped heating body 310 and both the electrode members 33, 34 can be also arranged within the rectangular frame body 40 manufactured by resin and shown in FIGS. 7A and 8. In this case, these members 31, 310, 33, 34 can be protected by using the frame body 40.

### Eighth Embodiment

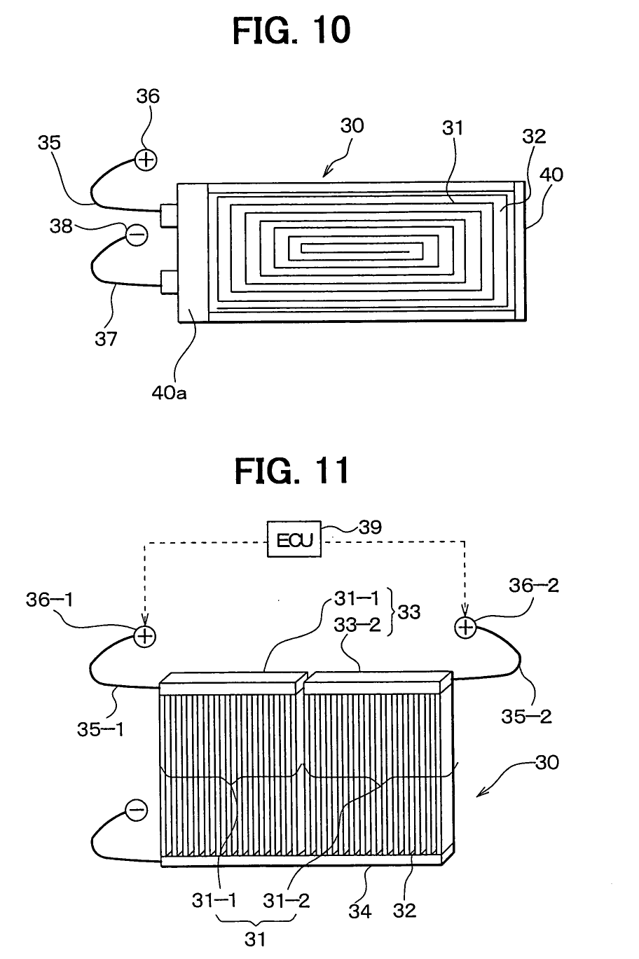

The eighth embodiment of the present invention will be now described with reference to FIG. 10. In this eighth embodiment, the heating body plate 31 is arranged within the rectangular frame body 40 in a rectangular spiral shape by interposing an air gap portion at a predetermined interval. The rectangular frame body 40 is made of resin. An air passage 32 for passing the air is formed by the spiral air gap portion. That is, a single heating body plate 31 is formed in the spiral shape to have the air gap portion between the formed spiral plate parts of the single heating body plate 31. In this example shown in FIG. 10, the single heating body plate is bent in the rectangular spiral shape. However, the single heating body plate can be bent in the other spiral shape. In the eighth embodiment, similar to FIG. 7B, auxiliary electrode members 330, 340 are integrally molded in both end portions of the heating body plate 31 in the air flow direction “a” (the direction perpendicular to the paper sheet face of FIG. 10). These auxiliary electrode members 330, 340 are electrically connected to lead wires 35, 37 through electrode members 33, 34 (not shown in FIG. 10) arranged within the frame portion 40a of the frame body 40.

In accordance with the eighth embodiment, air passing through the air passage 32 of the spiral shape can be directly efficiently heated by the heating body plate 31 of the spiral shape.

In the eighth embodiment, the heating body plate 31 can have protrusion portions protruding from at least one of face and back surfaces of the heating body plate to the air passage. Further, the heating body plate can be molded by using an electrically conductive resin in which an electrical conductive filler is mixed to have an electrical conductivity. For example, the electrically conductive resin has a positive resistance temperature characteristic in which an electrical resistance increases at a predetermined temperature or more.

Further, the heating body plate 31 can be molded integrally with the positive electrode member 33 and the negative electrode member 34. In addition, it is also possible to independently control electrical power to be supplied to plural areas of the heating body plate 31.

### Ninth Embodiment

In each of the above embodiments, only the positive electrode terminal portion 36 and the negative electrode terminal portion 38 are connected to the heating body plate 31 or the block-shaped heating body 310. In this case, the turning-on and turning-off operations of the heating body plate 31 or the block-shaped heating body 310 are controlled by the control device 39 (FIG. 2) through both the terminal portions 36, 38.

In contrast to this, in the ninth embodiment, the heating body plate 31 is partitioned into plural areas, and the current control operation of each heating body plate 31 in these plural areas can be independently performed.

In the ninth embodiment, as shown in FIG. 11, the positive electrode member 33 located in the upper end portions of the plural heating body plates 31 is divided into a positive electrode part 33-1 on the left-hand side and a positive electrode part 33-2 on the right-hand side. An air gap having a predetermined interval is provided between both these left and right positive electrode parts 33-1 and 33-2, and electrically insulates these left and right positive electrode parts 33-1 and 33-2 from each other.

The plural heating body plates 31 are also partitioned into heating body plates 31-1 on the left-hand side electrically joined to the positive electrode part 33-1, and heating body plates 31-2 on the right-hand side electrically joined to the positive electrode part 33-2. Both the lower end portions of each heating body plate 31-1 on the left-hand side and each heating body plate 31-2 on the right-hand side are electrically joined to a common negative electrode member 34.

The positive electrode part 33-1 on the left-hand side is connected to a positive electrode terminal portion 36-1 on the left-hand side through a left-hand side lead wire 35-1. The positive electrode part 33-2 on the right-hand side is connected to a positive electrode terminal portion 36-2 on the right-hand side through a right-hand side lead wire 35-2. Voltages applied to these left and right positive electrode terminal portions 36-1, 36-2 are independently controlled by the control device 39.

Accordingly, the heating amount of the heating body plates 31-1 on the left-hand side and the heating amount of the heating body plates 31-2 on the right-hand side can be independently controlled by the output of the control device 39. Therefore, the blowing-out temperature of air on the left-hand side area and the blowing-out temperature of air on the right-hand side area in the electrical heater 30 can be independently controlled in accordance with the requests of passengers in the immediate heating operation.

In FIG. 11, left and right independent control of air blown out from the electrical heater 30 has been described. However, the heating body plates 31 of the electrical heater 30 can be partitioned into four areas constructed with upper and lower and left and right areas. In this case, the heating amounts of the heating body plates 31 in the four areas can be independently controlled.

In FIG. 11, the plural heating body plates 31 are arranged in parallel with each other. However, when the heating body block 310 of FIG. 9 is used, similar effects can be also obtained if the heating body block 310 is divided into plural block parts and the current flowing operations of these plural heating body blocks 310 can be independently controlled.

### Tenth Embodiment

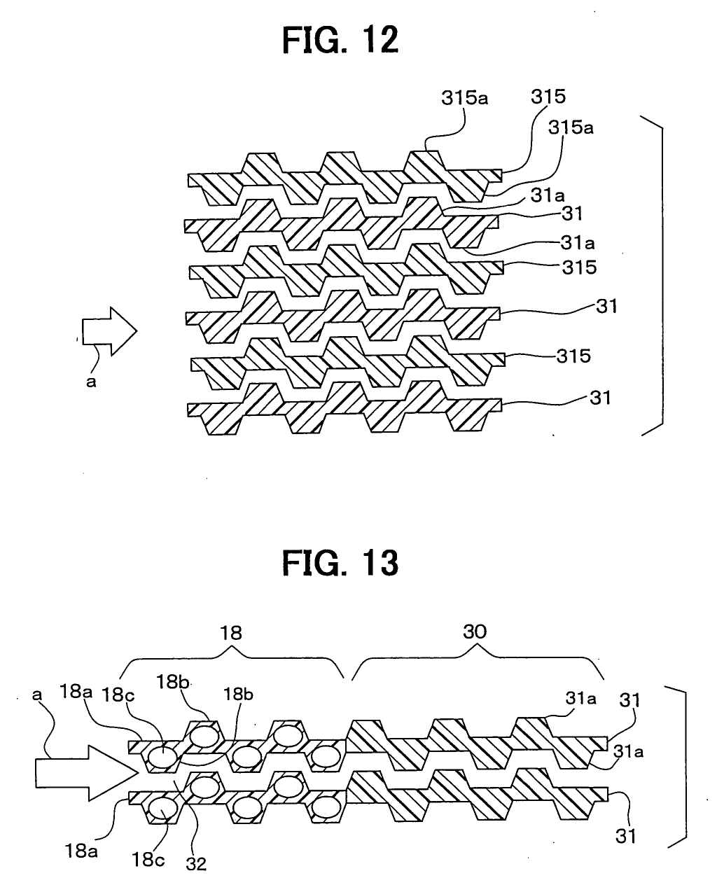

The tenth embodiment of the present invention will be now described with reference to FIG. 12. In the tenth embodiment, as shown in FIG. 12, a heating body plate 31 made of electrically conductive resin and a non-heating body plate 315 made of normal resin (electric insulating material) are alternately arranged in parallel with each other. Similarly to FIG. 5C, projecting portions 31a, 315a are formed in the heating body plate 31 and the non-heating body plate 315 and are alternately projected onto both the front and rear faces so as to disturb the air flow of the air passage 32. In the example of FIG. 12, the projecting shapes of the projecting portions 31a, 315a are set to trapezoidal solid shapes.

In accordance with the tenth embodiment, the electrical heater 30 having a different heating amount can be easily obtained by selecting the number of heating body plates 31 in accordance with a required heating amount while the size of the electrical heater 30 is constantly maintained.

### Eleventh Embodiment

In the eleventh embodiment, as shown in FIG. 13, a heating heat exchanger 18 (heater core) of a hot water type shown in FIG. 1 and the electrical heater 30 are integrally formed to construct a heat exchanger for heating air.

Plural (only two is shown in FIG. 13) heat transfer plate members 18a of the heating heat exchanger 18 are arranged in parallel with each other at a predetermined interval, and an air passage 32 is formed between these heat transfer plate members 18a. Further, projecting portion 18b are formed in the heat transfer plate member 18a and are alternately projected in a trapezoidal shape from both the front and rear faces of the heat transfer plate member 18a onto the air passage 32. A water passage 18c of a circular shape in cross-section for flowing hot water (engine cooling water) is formed in the inside portion of each projecting portion 18b. This water passage 18c is extended in the direction perpendicular to the air flow direction “a”.

The heating body plate 31 of the electrical heater 30 is integrally formed with the transfer plate member 18a of the heating heat exchanger 18 at a downstream end portion of the heat transfer plate member 18a of the heating heat exchanger 18 in an air flow direction “a”. Similarly to the heat transfer plate member 18a, trapezoidal projecting portions 31a are formed in the heating body plate 31. In this example shown in FIG. 13, each of the projection portions 31a is a solid projection without a hollow.

The heat transfer plate member 18a is made of resin such as polyamide resin having an excellent heat resisting property. Accordingly, the heat transfer plate member 18a and the heating body plate 31 can be integrally molded by a method of two-color molding.

The coefficient of thermal conductivity of the resin material constituting the heat transfer plate member 18a is very lower than that of a metal such as aluminum, etc. However, the present inventors have confirmed that a reduction in heating performance (heat radiating amount) can be restrained to a very small value by setting the plate thickness of a portion around the water passage 18c of the heat transfer plate member 18a to a small value such as about in a range between 0.1 and 0.4 mm in comparison with a case in which the heat transfer plate member 18a is constructed with aluminum.

In the eleventh embodiment, in a case where the immediate heating operation is performed by flowing the electric current through the heating body plate 31, when the generation heat of the heating body plates 31 is adsorbed to the low temperature water within the water passages 18c, a problem is caused in that no air of the air passage 32 can be efficiently heated by the generation heat of the heating body plates 31. However, the heat transfer plate member 18a is not constructed with a metal but is constructed with the resin material and the coefficient of thermal conductivity is very low. Thus, no heat movement to the low temperature water is almost caused even when the heat transfer plate member 18a and the heating body plate 31 are integrally molded. Accordingly, the air passing through the air passage 32 can be efficiently heated by the generation heat of the heating body plate 31.

Both end portions of each water passage 18c of the heat transfer plate member 18a (both end portions in the direction perpendicular to the paper sheet face of FIG. 13) are connected to unillustrated water inlet and outlet side tank portions so that the water (hot water) from the vehicle engine (a vehicle-mounted hot water source) is circulated in each water passage 18c of the heat transfer plate member 18a. Namely, the hot water from the vehicle engine is flowed from the hot water inlet side tank portion into one end portion of each water passage 18c. When this flowed-in hot water passes through the water passage 18c, the flowed-in hot water is thermally exchanged with the air of the air passage 32 so that the air passing through the heating heat exchanger is heated. The hot water after performing the heat exchange with the air flows from the other end portion of each water passage 18c into the water outlet side tank portion, and is returned from this water outlet side tank portion to the vehicle engine side.

### Other Embodiments

Although the present invention has been fully described in connection with the preferred embodiments thereof with reference to the accompanying drawings, it is to be noted that various changes and modifications will become apparent to those skilled in the art.

For example, in each of the above embodiments of the present invention, the electrically conductive resin is used as concrete materials of the heating body plate 31 and the block-shaped heating body 310. However, in addition to the electrically conductive resin, a metallic electric resistance material such as a nickel chromium alloy, etc. or a semiconductor can be used as the materials of the heating body plate 31 and the block-shaped heating body 310.

In each of the above embodiments, it is not described that surface processing of the heating body plate 31 and the block-shaped heating body 310 is performed. However, a surface processing layer can be formed for the purpose of electric insulation, waterproof, etc. in a thin film shape on the surfaces of the heating body plate 31 and the block-shaped heating body 310.

The electrical heater in the present invention is not limited to be used for the vehicle air conditioner, but can be used for various devices.

Such changes and modifications are to be understood as being within the scope of the present invention as defined by the appended claims.

What is claimed is:

1. An electrical heater comprising:
a first heating body plate made of a material to generate heat when electrical power is applied; and
a first plate member placed to have a first side facing a first side of the heating body plate so that the first plate member and the first heating body plate define a first air passage therebetween, the first air passage passing air to be heated, wherein
the first heating body plate and the first plate member are alternately projected along an air flow direction in the first air passage so as to disturb the air flow in the first air passage.

2. The electrical heater according to claim 1, wherein the first heating body plate has a plurality of projecting portions projecting toward the plate member, and
the first plate member has a plurality of projecting portions projecting toward the first heating body plate.

3. The electrical heater according to claim 1, further comprising a second plate member placed to face a second side of the first heating body plate so that the second plate member and the first heating body plate define a second air passage therebetween, the second air passage passing air to be heated, wherein the first heating body plate and the second plate member are alternately projected along an air flow direction in the second air passage so as to disturb the air flow in the second air passage.

4. The electrical heater according to claim 3, wherein the first heating body plate has a plurality of projecting portions on the first side and a plurality of recess portions on the second side behind the projecting portions.

5. The electrical heater according to claim 3, wherein the first heating body plate has a plurality of projecting portions on both the first and second sides and a plurality of recess portions on the second side behind the projecting portions.

6. The electrical heater according to claim 3, wherein the first heating body plate has a plurality of projecting portions projecting from both the first and second sides toward the first and second plate members, the projecting portions being arranged in an alternate fashion along the flow direction, and
each of the plate members has a plurality of projecting portions projecting toward the heating body plate.

7. The electrical heater according to claim 1, further comprising a second heating body plate placed to face a second side of the first plate member so that the second heating body plate and the first plate member define a second air passage therebetween, the second air passage passing air to be heated, wherein
the second heating body plate and the first plate member are alternately projected along an air flow direction in the second air passage so as to disturb the air flow in the second air passage.

8. The electrical heater according to claim 7, wherein the first plate member has a plurality of projecting portions on the first side and a plurality of recess portions on the second side behind the projecting portions.

9. The electrical heater according to claim 7, wherein the first plate member has a plurality of projecting portions on both the first and second sides and a plurality of recess portions on the second side behind the projecting portions.

10. The electrical heater according to claim 7, wherein the first plate member has a plurality of projecting portions projecting from both the first and second sides toward the first and second heating body plates, the projecting portions being arranged in an alternate fashion along the flow direction, and
each of the heating body plates has a plurality of projecting portions projecting toward the first plate member.

11. The electrical heater according to claim 1, wherein the first heating body plate and the first plate member are formed in the same cross sectional shape and are placed in parallel with each other.

12. The electrical heater according to claim 1, wherein the first heating body plate has a plurality of projecting portions projecting toward the first plate member, wherein
the projecting portions have thickness thicker than that of portions between the projecting portions.

13. The electrical heater according to claim 1, wherein the first heating body plate has uniform thickness.

14. The electrical heater according to claim 1, wherein the first heating body plate is made of electrically conductive resin, and the first plate member is made of electric insulating material.

15. The electrical heater according to claim 1, wherein the first plate member is made of a material which generates heat when electrical power is applied.

16. The electrical heater according to claim 1, further comprising a first heat transfer plate in which a first fluid passage is formed, the fluid passage being supplied with hot medium, the heat transfer plate being integrated with the first heating body plate.

17. The electrical heater according to claim 16, wherein the heat transfer plate is placed on an upstream side to the first heating body plate with respect to the air flow direction in the first air passage.

18. The electrical heater according to claim 16, wherein the heat transfer plate is alternately projected along the air flow direction in the first air passage so as to disturb the air flow in the first air passage.

19. The electrical heater according to claim 16, further comprising a second heat transfer plate in which a second fluid passage is formed, the second fluid passage being supplied with hot medium, the second heat transfer plate being integrated with the first plate member and being placed to face one side of the first heat transfer plate, the first and second heat transfer plates being alternately projected along the air flow direction in the first air passage so as to disturb the air flow in the first air passage.

20. The electrical heater according to claim 19, wherein the first plate member is made of a material which generates heat when electrical power is applied.
